(19) United States
(12) Patent Application Publication
(10) Pub. No.: US 2021/0253268 A1
(43) Pub. Date: Aug. 19, 2021

(54) SYSTEMS AND METHODS THAT OPTIMIZE SPEED BRAKE OPERATIONS

(71) Applicant: HONEYWELL INTERNATIONAL INC., Charlotte, NC (US)

(72) Inventors: Karen Borges, Phoenix, AZ (US); Mahesh Dayalan, Bangalore (IN); Mathew Philipose, Bangalore (IN); SaiKrishna Nadipalli, Bangalore (IN); Sudhakar Choudhary, Bangalore (IN); Anand Krishna, Bangalore (IN)

(73) Assignee: HONEYWELL INTERNATIONAL INC., Charlotte, NC (US)

(21) Appl. No.: 17/098,624

(22) Filed: Nov. 16, 2020

(30) Foreign Application Priority Data
Jan. 20, 2020 (IN) 202011002502

(51) Int. Cl. B64D 43/02; B64C 19/00; G01C 23/00

(52) U.S. Cl. CPC B64D 43/02; G01C 23/005; B64C 19/00

(57) ABSTRACT

Systems and methods for optimizing the operation of speed brakes in an aircraft. The method includes, upon receipt from a flight management system (FMS), a drag required notification that the aircraft has departed an assigned descent path, calculating an optimized operation of the speed brakes required to put the aircraft back on the assigned descent path; and displaying, on a display system, a speed-alert widget with accompanying text that advises the optimized operation of the speed brakes.

### CROSS REFERENCE TO RELATED APPLICATION

This application claims priority to Indian Provisional Patent Application No. 202011002502, filed Jan. 20, 2020, the entire content of which is incorporated by reference herein.

### TECHNICAL FIELD

The technical field generally relates to flight guidance systems, and more particularly relates to flight guidance systems that optimize speed brake operations.

### BACKGROUND

Presenting relevant and critical information to pilots without cluttering the screen and/or occluding other relevant information is an ongoing technical problem. Additionally, determining which information is the most relevant to present for each phase of flight, or segment, is an ongoing technical problem.

With regard to a descent, generally, a Flight Management System (FMS) on an aircraft constructs a descent path for the aircraft to follow to sequentially transition from the cruise phase of flight to the arrival phase of flight to the approach segment and to the destination runway and monitors the aircraft location and state with respect to the constructed descent path.

In some available flight guidance systems, when the aircraft departs the constructed descent path, the FMS generates a notification. Different original equipment manufacturers (OEMs) of aircraft provide different FMS notifications. Regardless of the form of the FMS notification, specific guidance for speed brakes can be lacking.

Accordingly, improved flight guidance systems and methods that present critical information to pilots in speed-alert scenarios are desired. Specifically, systems and methods that optimize speed brake operations in speed-alert scenarios are desired. The following disclosure provides these technological enhancements, in addition to addressing related issues.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In an embodiment, a processor-implemented method for optimizing the operation of speed brakes in an aircraft, including: upon generation of, by a flight management system (FMS), a speed-alert that the aircraft has departed an assigned descent path, calculating a position of the speed brakes that will put the aircraft back on the assigned descent path; and displaying, on display system, a widget with accompanying text that advises the position of the speed brakes responsive to the speed-alert.

Also provided is a system for optimizing the operation of speed brakes in an aircraft, including: a source of a speed-alert that the aircraft has departed an assigned descent path; and a control module comprising a processor and programmed to receive the speed-alert; calculate, responsive to the speed-alert, a position of the speed brakes required to put the aircraft back on the assigned descent path, the position is from among fully extended, partially extended, and fully retracted; and display, on a display system, a speed-brake widget with accompanying text that advises the position of the speed brakes in response to the speed-alert.

In an embodiment, an aircraft is provided. The aircraft including: a flight management system (FMS) that generates a speed-alert that the aircraft has departed an assigned descent path; a speed brakes system; a display system; and a control module operationally coupled to the FMS, the speed brakes system, the display system; the control module comprising a processor programmed to calculate, in response to the speed-alert, an optimized operation of the speed brakes required to put the aircraft back on the assigned descent path, wherein the optimized operation of the speed brakes includes a position from among fully extended, partially extended, and fully retracted, partially extended including a magnitude of application of the speed brakes associated with between 0 and 100 percent extended; and display, on the display system, (i) a speed-brake widget with accompanying text that advises the optimized operation of the speed brakes in response to the speed-alert, and (ii) alphanumeric information indicating the magnitude associated with the position of the speed brakes.

Furthermore, other desirable features and characteristics of the system and method will become apparent from the subsequent detailed description and the appended claims, taken in conjunction with the accompanying drawings and the preceding background.

### BRIEF DESCRIPTION OF THE DRAWINGS

The present application will hereinafter be described in conjunction with the following drawing figures, wherein like numerals denote like elements, and:

FIG. 1 is a block diagram of a system for optimizing the operation of speed brakes in an aircraft, in accordance with an exemplary embodiment;

FIGS. 2-3 are illustrations of a CDU help window showing a computed optimum speed brake magnitude, in accordance with an exemplary embodiment;

FIGS. 4-5 are illustrations showing a dedicated area on an engine indicating and crew alerting system (EICAS) page for a speed brake widget, in accordance with an exemplary embodiment;

FIGS. 6-7 depict the speed brake widget including a trend indicator, in accordance with an exemplary embodiment;

FIG. 8 is an illustration showing a depiction of optimizing the operation of speed brakes on a cockpit display having a horizontal display and a vertical situation display, in accordance with an exemplary embodiment; and

FIG. 9 is a flow chart for a method for how optimizing the operation of speed brakes, in accordance with an exemplary embodiment.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Thus, any embodiment described herein as “exemplary” is not necessarily to be construed as preferred or advantageous over other embodiments. The embodiments described herein are exemplary embodiments provided to enable persons skilled in the art to make or use the invention and not to limit the scope of the invention that is defined by the claims. Furthermore, there is no intention to be bound by any expressed or implied theory presented in the preceding technical field, background, summary, or the following detailed description.

As mentioned, a constructed descent path is an assigned descent path for the aircraft to follow to sequentially transition from the cruise phase of flight (start) to the arrival phase of flight to the approach segment and to the destination runway (end). A Flight Management System (FMS) on an aircraft generally performs complex and multifaceted energy management to construct the descent path from start to end.

Also as mentioned, in some available flight guidance systems, when the aircraft has departed an assigned descent path, the FMS may generate a notification. The notification that the FMS generates in these scenarios is usually textual and displayed on a cockpit display. Different original equipment manufacturers (OEMs) of aircraft provide different FMS notifications. In some aircraft, the FMS generates a “DRAG REQUIRED” text notification to advise the pilot of speed changes required to maintain the descent path. On other aircraft, the FMS generates an “EXTEND SPEED BRAKES” and/or a “RETRACT SPEED BRAKES” text notification to advise the pilot of speed changes required to maintain the descent path. When the pilot sees the FMS notification, the pilot must figure out exactly how to respond with available equipment, such as speed brakes and throttles. For simplifying purposes, the textual notification to indicate that the aircraft has departed an assigned descent path is referred to herein as a speed-alert, and the FMS is an exemplary source of a speed-alert. Additionally, once the speed-alert is generated, as used herein, the aircraft may be in a speed reduction mode until the speed-alert scenario ends, during which time the pilot has to continually figure out how to respond to the speed-alert. The speed-alert scenario ends when the aircraft returns to its assigned descent path. Accordingly, responding to the speed-alert is a technical problem. A technical problem remains, in that the aforementioned speed-alerts don't provide specific equipment detail or optimizing recommendations for available equipment.

Embodiments disclosed herein provide a technical solution to this technical problem. Exemplary embodiments of the improved flight guidance systems and methods display critical information to pilots to optimize operation of the speed brakes in response to a speed-alert. Some embodiments of the improved flight guidance systems and methods also present critical information to pilots to optimize application of the throttle in response to the speed-alert. Further, in various embodiments, techniques for attracting visual attention (such as a widget shape, color rendering, and widget location) enhance the human-machine interface and additionally contribute to the provided technical solution.

In the exemplary embodiments, the descent path includes a path/trajectory from start to end, and the FMS may also calculate, for each phase or segment, a respective speed tolerance (referred to as limit speeds and including an upper limit speed and a lower limit speed) to allow for unknown winds. When the aircraft speed reaches, in any phase or segment, either of the limit speeds while performing the descent, the aircraft has departed its assigned descent path and is in a speed-alert scenario. Sometimes, when the aircraft is in a speed-alert scenario, such as due to an unforeseen wind, the aircraft may depart the constructed descent path. The figures and descriptions below provide more detail.

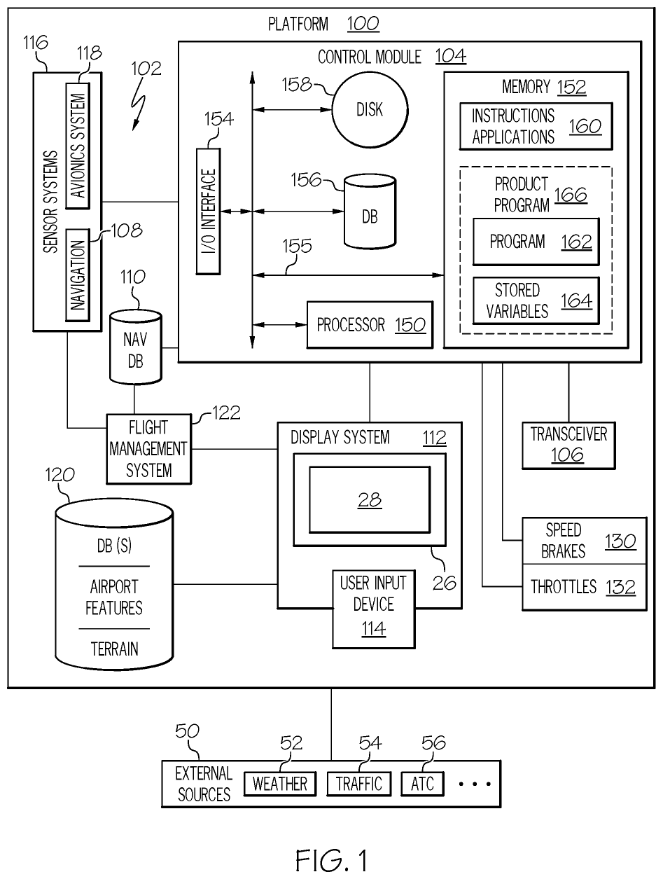

Turning now to FIG. 1, in an embodiment, the system for providing dynamic readouts for primary flight displays 102 (also referred to herein as “system” 102) is generally located in a mobile platform 100. In various embodiments, the mobile platform 100 is an aircraft, and is referred to as aircraft 100. The system 102 embodies a control module 104 (which is depicted in a functional form as an enhanced computer system). Although the control module 104 is shown as an independent functional block, the control module 104 may be integrated within a preexisting mobile platform management system, avionics system, cockpit display system (CDS), flight controls system (FCS), or aircraft flight management system (FMS 122). Although the control module 104 is shown onboard the aircraft 100, optionally, it may exist in an optional electronic flight bag (EFB). In embodiments in which the control module is within an EFB, the display system 112 and user input device 114 may also be part of the EFB. Further, in some embodiments, the control module 104 may reside in a portable electronic device (PED) such as a tablet, cellular phone, or the like.

The control module 104 performs the processing functions of the system 102. To perform these functions, the control module 104 may be operatively coupled to any combination of the following aircraft systems: a source of real-time aircraft status data, such as a navigation system 108; a source of prescribed flight plan data, such as a navigation database (NavDB 110); and, a display system 112. In various embodiments, the control module 104 is additionally operationally coupled to one or more of: a transceiver 106; a user input device 114; one or more databases 120; a flight management system (FMS 122); a speed brakes 130 system; a throttle 132 system; and one or more avionics systems sensors 118. The functions of these aircraft systems, and their interaction, are described in more detail below.

The navigation system 108 is a type of sensor system 116. The navigation system 108 is configured to provide real-time navigation data and/or information regarding operation of the aircraft 100. As used herein, “real-time” is interchangeable with current and instantaneous. The navigation system 108 may be realized as including a global positioning system (GPS), inertial reference system (IRS), or a radio-based navigation system (e.g., VHF omni-directional radio range (VOR) or long-range aid to navigation (LORAN)), and may include one or more navigational radios or other sensors suitably configured to support operation of the FMS 122, as will be appreciated in the art. The data provided by the navigation system 108 is referred to as navigation data (also referred to herein as aircraft status data). Aircraft status data may include any of: an instantaneous position (e.g., the latitude, longitude, orientation), a flight path angle, a vertical speed, a ground speed, an instantaneous altitude (or height above ground level), an instantaneous heading of the aircraft 100 (i.e., the direction the aircraft is traveling in relative to some reference), and a current phase of flight. The real-time aircraft status data, or navigation data, is made available such that the display system 112, the transceiver 106, and the control module 104, may further process and/or handle the aircraft status data.

Prescribed flight plan data may include a series of intended geospatial midpoints between a departure and an arrival, as well as performance data associated with each of the geospatial midpoints (the performance data including intended navigation data such as intended airspeed, intended altitude, intended acceleration, intended flight path angle, and the like). A source of a prescribed flight plan data may be a storage location or a user input device. In various embodiments, the NavDB 110 is the source of a prescribed flight plan. The navigation database (NavDB 110) is a storage location that may also maintain a database of flight plans, and/or information regarding terrain and airports and/or other potential landing locations (or destinations) for the aircraft 100. In operation, the navigation system 108 and the NavDB 110 may be integrated with a FMS 122.

The avionics system(s) 118 is another type of sensor system 116. In various embodiments, the avionics system(s) 118 provide aircraft performance data and feedback for subsystems on the aircraft 100. Examples of the aircraft performance data include: engine thrust level, fuel level, braking status, temperature control system status, and the like. As may be appreciated, the avionics system(s) 118 may therefore include a variety of on-board detection sensors, and, as part of the sensor systems 116, may be operationally coupled to the FMS 122.

In various embodiments, the FMS 122, in cooperation with the sensor systems 116 and the NavDb 110, provides real-time flight guidance for aircraft 100. The FMS 122 is configured to compare the instantaneous position and heading of the aircraft 100 with a prescribed flight plan for the aircraft 100. To this end, in various embodiments, the NavDB 110 supports the FMS 122 in maintaining an association between a respective airport, its geographic location, runways (and their respective orientations and/or directions), instrument procedures (e.g., approach procedures, arrival routes and procedures, takeoff procedures, and the like), airspace restrictions, and/or other information or attributes associated with the respective airport (e.g., widths and/or weight limits of taxi paths, the type of surface of the runways or taxi path, and the like). In various embodiments, the FMS 122 also supports controller pilot data link communications (CPDLC), such as through an aircraft communication addressing and reporting system (ACARS) router; this feature may be referred to as a communications management unit (CMU) or communications management function (CMF). Accordingly, in various embodiments, the FMS 122 may be a source for the real-time aircraft status data of the aircraft 100.

The display system 112 includes a display device 26 for presenting an image 28. The display system 112 is configured to continuously receive and process real-time aircraft status data and flight plan information. In various embodiments, the display system 112 formats and renders information received from the FMS 122, as well as external sources 50. In various embodiments, the display system 112 may directly receive input from an air data heading reference system (AHRS), an inertial reference system (IRS), the navigation system 108, or the FMS 122. The control module 104 and the display system 112 are cooperatively configured to generate the commands (“display commands”) for the display device 26 to render thereon the image 28, comprising various graphical user interface elements, tables, menus, buttons, and pictorial images, as described herein. In exemplary embodiments, the display device 26 is realized on one or more electronic display devices configured as any combination of: a head up display (HUD), an alphanumeric display, a vertical situation display (VSD) and a lateral navigation display (ND). The display device 26 is responsive to display commands from the control module 104 and/or display system 112.

Renderings on the display system 112 may be processed by a graphics system, components of which may be integrated into the display system 112 and/or be integrated within the control module 104. Display methods include various types of computer-generated symbols, text, and graphic information representing, for example, pitch, heading, flight path, airspeed, altitude, runway information, waypoints, targets, obstacles, terrain, and required navigation performance (RNP) data in an integrated, multi-color or monochrome form. Display methods also include various formatting techniques for visually distinguishing objects and routes from among other similar objects and routes, and for causing objects and symbols to fade-in and fade-out. As used herein, a fade-in and/or fade-out means changing between not being rendered at all (i.e., zero percent) and being fully rendered (i.e., 100%) in incremental steps. The control module 104 is said to display various images and selectable options described herein. In practice, this may mean that the control module 104 generates display commands, and, responsive to receiving the display commands from the control module 104, the display system 112 displays, renders, or otherwise visually conveys on the display device 26, the graphical images associated with operation of the aircraft 100, and specifically, the graphical images as described herein.

The user input device 114 and the control module 104 are cooperatively configured to allow a user (e.g., a pilot, co-pilot, or crew member) to interact with display devices in the display system 112 and/or other elements of the system 102, as described in greater detail below. Depending on the embodiment, the user input device 114 may be realized as a cursor control device (CCD), keypad, touchpad, keyboard, mouse, touch panel (or touchscreen), joystick, knob, line select key, voice controller, gesture controller, or another suitable device adapted to receive input from a user. When the user input device 114 is configured as a touchpad or touchscreen, it may be integrated with the display system 112. As used herein, the user input device 114 may be used to for a pilot to accept a runway change or to request a runway change.

In various embodiments, any combination of the FMS 122, user input device 114, and transceiver 106, may be coupled to the display system 112 such that the display system 112 may additionally generate or render, on a display device 26, real-time information associated with respective aircraft 100 components. Coupled in this manner, the FMS 122 and transceiver 106 are configured to provide navigation information to support navigation, flight planning, and other aircraft control functions in a conventional manner, as well as to provide real-time data and/or information regarding the operational status of the aircraft 100 to the control module 104. In some embodiments, the user input device 114, FMS 122, and display system 112 are configured as a control display unit (CDU).

External sources 50 communicate with the aircraft 100, generally by way of transceiver 106. External sources include: weather and surface data sources (weather 52), such as a source for meteorological terminal aviation weather reports (METARS), automatic terminal information service (ATIS), datalink ATIS (D-ATIS), automatic surface observing system (ASOS); traffic data system(s) 54; air traffic control (ATC) 56; and a variety of other radio inputs. The traffic data system(s) 120 include numerous systems for providing real-time neighbor/relevant traffic data and information. For example, traffic data sources 54 may include any combination of: traffic collision avoidance system (TCAS), automatic dependent surveillance broadcast (ADS-B), traffic information system (TIS), crowd sourced traffic data and/or another suitable avionics system. Flight traffic information that is received from the traffic data system may include, for each neighbor aircraft of a plurality of neighbor aircraft, one or more of a respective (i) instantaneous position and location, vertical speed, and ground speed, (ii) instantaneous altitude, (iii) instantaneous heading of the aircraft, and (iv) aircraft identification. Information received from external sources may be processed as one or more information layers (for example, a weather layer, a traffic layer, and the like) and layers may be selectively overlaid on an existing image 28.

The transceiver 106 is configured to support instantaneous (i.e., real time or current) communications between the aircraft 100 and the one or more external data source(s) 50. As a functional block, the transceiver 106 represents one or more transmitters, receivers, and the supporting communications hardware and software required for the system 102 to communicate with the various external data source(s) 50 as described herein. In an example, the transceiver 106 supports bidirectional pilot-to-ATC (air traffic control) communications via a datalink. In addition to supporting the data link system, the transceiver 106 is configured to include or support an automatic dependent surveillance broadcast system (ADS-B), a communication management function (CMF) uplink, a terminal wireless local area network (LAN) unit (TWLU), or any other suitable radio communication system that supports communications between the aircraft 100 and the various external source(s) 50. In this regard, the transceiver 106 may allow the aircraft 100 to receive information that would otherwise be unavailable to the pilot and/or co-pilot using only the onboard systems.

In various embodiments, the control module 104 is additionally operationally coupled to one or more databases 120. The databases 120 may include an airport features database, having therein maps and geometries, as well as airport status data for the runways and/or taxi paths at the airport; the airport status data indicating operational status and directional information for the taxi paths (or portions thereof). Additionally, the databases 120 may include a terrain database, having therein topographical information for the airport and surrounding environment.

As mentioned, the control module 104 performs the functions of the system 102. As used herein, the term “module” refers to any means for facilitating communications and/or interaction between the elements of the system 102 and performing additional processes, tasks and/or functions to support operation of the system 102, as described herein. In various embodiments, the control module 104 may be any hardware, software, firmware, electronic control component, processing logic, and/or processor device, individually or in any combination. In various embodiments, the control module 104 may be implemented or realized with: a general purpose processor (shared, dedicated, or group) controller, microprocessor, or microcontroller, and memory that executes one or more software or firmware programs embodying the algorithms and tasks described herein; a content addressable memory; a digital signal processor; an application specific integrated circuit (ASIC), a field programmable gate array (FPGA); any suitable programmable logic device; combinational logic circuit including discrete gates or transistor logic; discrete hardware components and memory devices; and/or any combination thereof, designed to perform the functions described herein.

Accordingly, in FIG. 1, an embodiment of the control module 104 is depicted as an enhanced computer system including a processor 150 and a memory 152. The processor 150 may comprise any type of processor or multiple processors, single integrated circuits such as a microprocessor, or any suitable number of integrated circuit devices and/or circuit boards working in cooperation to carry out the described operations, tasks, and functions by manipulating electrical signals representing data bits at memory locations in the system memory, as well as other processing of signals. The memory 152 may comprise RAM memory, ROM memory, flash memory, registers, a hard disk, or another suitable non-transitory short or long-term storage media capable of storing computer-executable programming instructions or other data for execution. The memory 152 may be located on and/or co-located on the same computer chip as the processor 150. Generally, the memory 152 maintains data bits and may be utilized by the processor 150 as storage and/or a scratch pad during operation. Specifically, the memory 152 stores instructions and applications 160. Information in the memory 152 may be organized and/or imported from an external data source 50 during an initialization step of a process; it may also be programmed via a user input device 114.

The novel program 162 includes rules and instructions which, when executed by the processor 150, cause the control module 104 to perform the functions, techniques, and processing tasks associated with the operation of the system 102. Novel program 162 and associated stored variables 164 may be stored in a functional form on computer readable media, as depicted, in memory 152. While the depicted exemplary embodiment is described in the context of a fully functioning computer system, those skilled in the art will recognize that the mechanisms of the present disclosure are capable of being distributed as a program product 166, with one or more types of non-transitory computer-readable signal bearing media used to store the program and the instructions thereof and carry out the distribution thereof, such as a non-transitory computer readable medium bearing the program 162 and containing computer instructions stored therein for causing a computer processor (such as the processor 150) to perform and execute the program 162. Such a program product 166 may take a variety of forms, and the present disclosure applies equally regardless of the type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments.

During operation, the processor 150 loads and executes one or more programs, algorithms and rules embodied as instructions and applications 160 contained within the memory 152 and, as such, performs the tasks and operations attributed herein to the general operation of the system 102. In specifically executing the processes described herein, the processor 150 loads the instructions, algorithms, and rules embodied in the program 162, thereby being programmed with program 162. During execution of program 162, the processor 150 and the memory 152 form the control module 104 that performs the processing activities of the system 102.

In various embodiments, the processor/memory unit of the control module 104 may be communicatively coupled (via a bus 155) to an input/output (I/O) interface 154, and a database 156. The bus 155 serves to transmit programs, data, status and other information or signals between the various components of the control module 104. The bus 155 can be any suitable physical or logical means of connecting computer systems and components. This includes, but is not limited to, direct hard-wired connections, fiber optics, infrared and wireless bus technologies.

The I/O interface 154 enables intra control module 104 communication, as well as communications between the control module 104 and other system 102 components, and between the control module 104 and the external data sources via the transceiver 106. The I/O interface 154 may include one or more network interfaces and can be implemented using any suitable method and apparatus. In various embodiments, the I/O interface 154 is configured to support communication from an external system driver and/or another computer system. Also, in various embodiments, the I/O interface 154 may support communication with technicians, and/or one or more storage interfaces for direct connection to storage apparatuses, such as the database 156. In one embodiment, the I/O interface 154 is integrated with the transceiver 106 and obtains data from external data source(s) directly.

The database 156 may include an aircraft-specific parameters database (comprising aircraft-specific parameters and configuration data for aircraft 100, as well as for a variety of other aircrafts) and parameters and instructions for processing user inputs and rendering images 28 on the display device 26, as described herein. In some embodiments, the database 156 is part of the memory 152. In various embodiments, the database 156 and the database 120 are integrated, either within the control module 104 or external to it. Accordingly, in some embodiments, the airport features and terrain features are pre-loaded and internal to the control module 104. Another form of storage media that may be included in, and utilized by, the control module 104 is an optional hard disk 158.

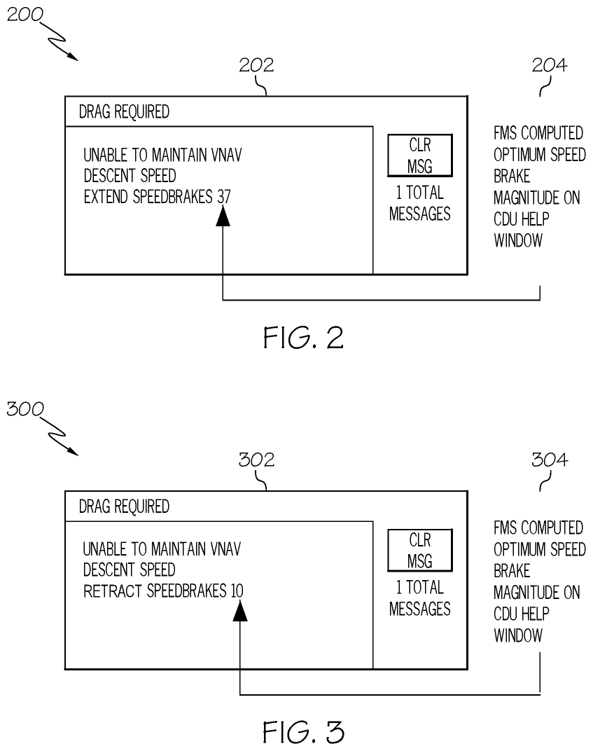

As mentioned, the technologically improved systems and methods provided herein provide critical information to pilots for optimizing speed brake operations during a descent. The technologically improved systems and methods utilize data from the FMS to calculate and provide an optimum amount of speed brakes and/or thrust in on speed-alert scenario to return to the constructed descent path. The technologically improved systems and methods can provide progressive alerts that show changes in the speed-alert conditions. The technologically improved systems and methods display an amount of speed brakes required using a widget on a graphical user interface, the display of the information being in an intuitive and easy to grasp manner, using various combinations of text and widgets, alphanumeric displays, horizontal displays, and/or vertical displays. FIGS. 2-8 provide examples of displayed information.

In FIG. 2, an alphanumeric display 200, such as may be found on a CDU help window, depicts the FMS generated “drag required” text 202, with the addition of (at 204): the added optimum speed brake magnitude of 37 alongside an “extend speed brakes” message. In FIG. 3, an alphanumeric display 300, such as may be found on a CDU help window, depicts the “drag required” text 302, and shows (at 304) the added optimum speed brake magnitude of 10 alongside a “retract speed brakes” message.

As used herein, the optimized operation of the speed brakes includes at least a position of the speed brakes 130 that will put the aircraft back on the assigned descent path. The position of the speed brakes 130 associated with the optimized operation of the speed brakes 130 is among fully extended (defined as 100 percent extended), partially extended, and fully retracted (defined as 0 percent extended), partially extended including a magnitude of application of the speed brakes associated with between 0 and 100 percent extended.

The speed brake widget incorporates a progressive indication of the percent extended that is determined to be the optimized operation of the speed brakes 130, wherein progressive indication means a smooth or continuous transition between 0 percent and 100. The control module 104 displays, on a display system 112, a speed brake widget with accompanying text that advises of the optimized operation of the speed brakes 130.

Likewise, in embodiments that calculate an optimized application of the throttles 132 in response to a speed-alert, the application of the throttles 132 is one of fully applied (defined as 100 percent thrust), partially applied, and 0 percent applied, partially applied having a magnitude of application of the throttle associated with between 0 and 100 percent applied.

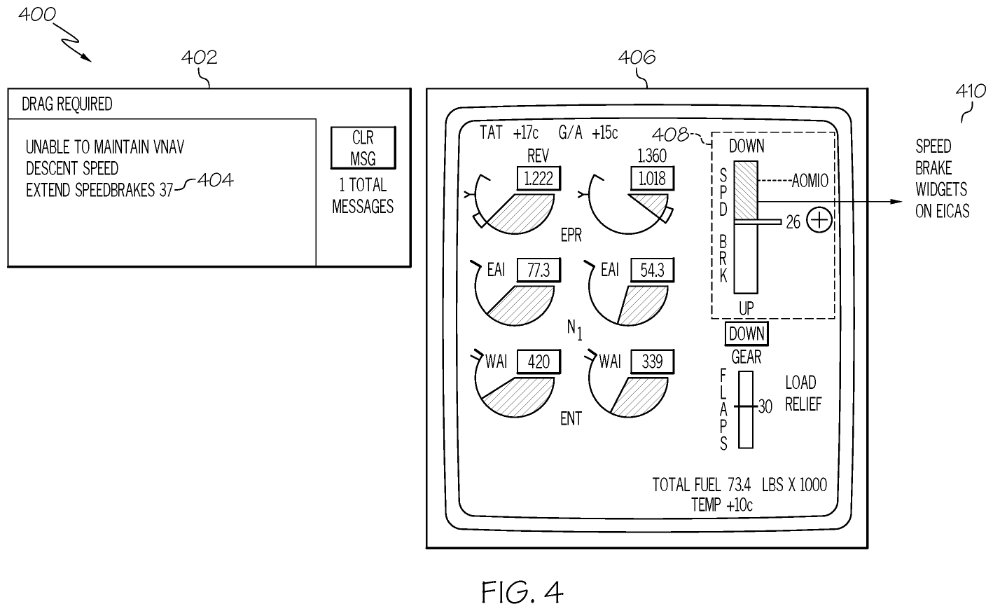

In various embodiments, as depicted in FIG. 4, the control module 104 displays, on the display system 112, a speed brake widget with accompanying text that also advises of the optimized application of the throttles 132 in response to a speed-alert. In FIG. 4, as in FIG. 3, the alphanumeric information on the CDU help window display 400 depicts the “drag required” 402 and has the accompanying text magnitude 37 associated with the optimized operation of the speed brakes 130 (at 404). In addition, as shown in FIG. 4, the control module 104 dedicates an area 408 on a page of an EICAS 406 for displaying a speed brake widget 410. The speed brake widget 410 can take a variety of forms, so long as it conveys the information as described herein. In the exemplary embodiment, the speed brake widget 410 is a vertical bar labeled “spd brk.”

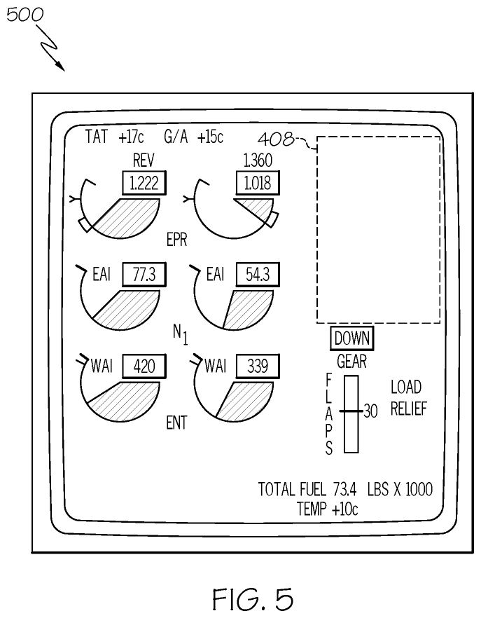

It is contemplated that when there is no “drag required” (or equivalent) notification from the FMS, or when this speed reduction mode is not required, the speed brake widget 410 would not be displayed, i.e., would be removed from the display or would otherwise be invisible, as shown in FIG. 5. In FIG. 5, the EICAS page 500 is depicted, and the area 408, dedicated to having a speed brake widget 410, does not have one displayed. Said differently, in various embodiments, the speed brake widget 410 only gets displayed on the EICAS page 500 upon the co-occurrence of (1) a speed-alert (for example, a DRAG REQUIRED notification) from the FMS, and (2) a speed reduction mode is active in the flight plan; otherwise, the control module 104 ceases displaying the speed brake widget and accompanying text when the aircraft has been brought back to its constructed descent path (also referred to as its assigned descent path).

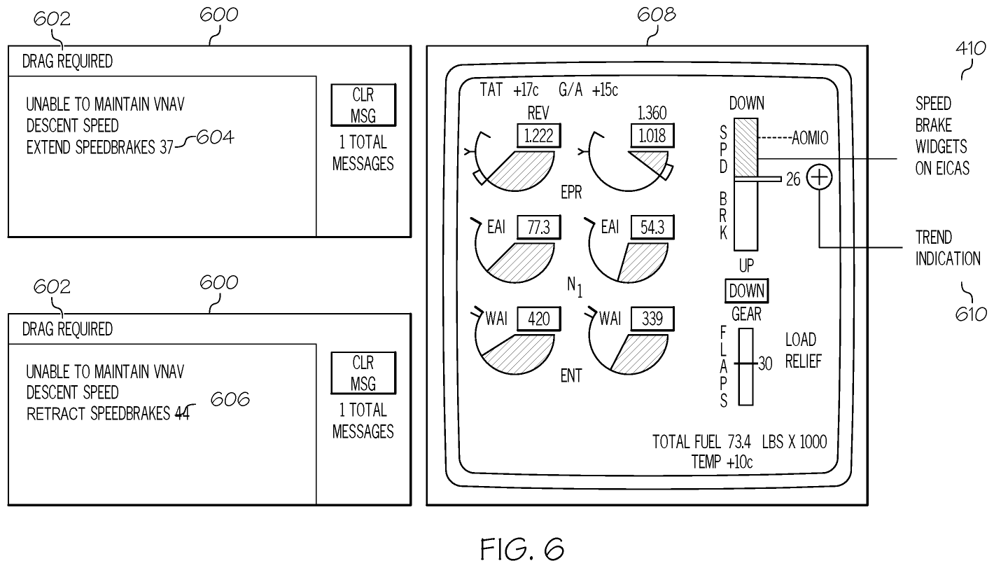

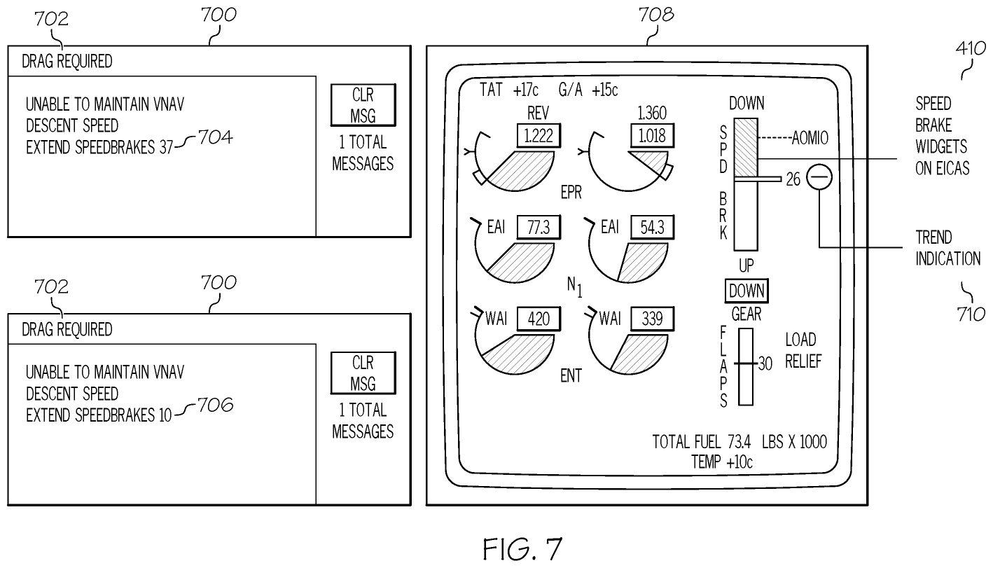

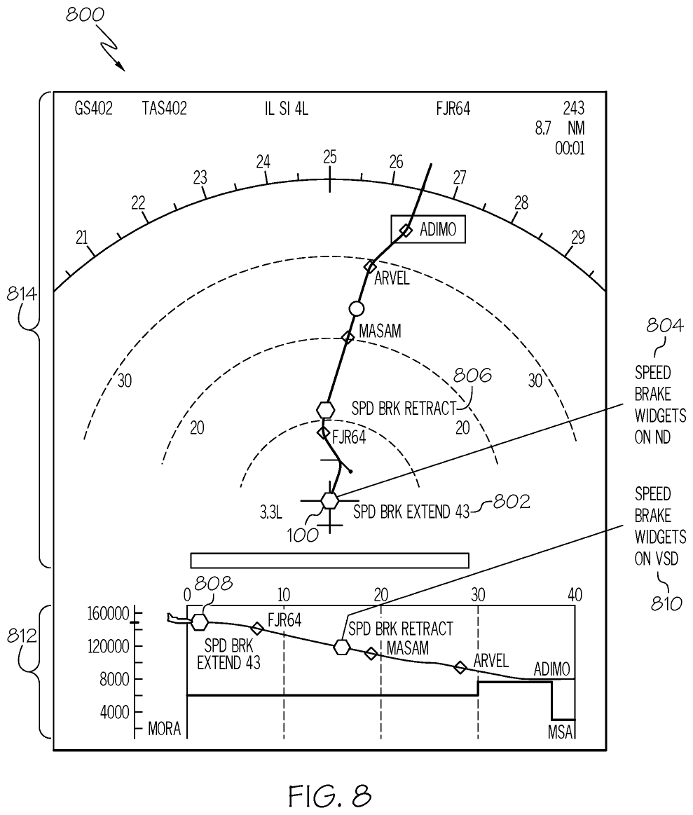

As depicted in FIGS. 6 and 7, in various exemplary embodiments, the system 102 generates a speed brake widget 410 that not only depicts that an application of the speed brakes 130 is required, but additionally depicts a trend of an application of the speed brakes 130 over time. In FIG. 6, the alphanumeric information on the CDU display 600 depicts the speed-alert “drag required” notification 602 per the FMS, and the system 102 therewith calculates and displays an optimized operation of the speed brakes 130 required to put the aircraft 100 back on the assigned descent path. In the example, the optimized operation of the speed brakes 130 include an “extend speed brakes” at magnitude 37 (indicated at 604); further, at a time (such as delta-t) later, the FMS is still generating the “drag required” notification 602, and the system 102 additionally calculates and displays an optimized operation of the speed brakes 130 including an “extend speed brakes” at magnitude 44 (indicated at 606). In this example, the control module 104 determines that the optimized application of the speed brakes 130 (i.e., the position of the speed brakes 130 required to put the aircraft back on the assigned descent path) went from magnitude 37 to magnitude 44, which indicates an increasing trend over time delta-t. In the example, the control module 104 renders the speed brake widget 410 with an increasing trend indication 610 on the EICAS page 608. The increasing trend indication 610 can take a variety of forms, so long as it conveys the information as described herein. In the exemplary embodiment, the increasing trend indication 610 is a plus sign within a circle.

In FIG. 7, the alphanumeric information on the CDU display 700 depicts the “drag required” notification 702 per the FMS, and the system 102 additionally calculates and displays an optimized extend speed brakes magnitude 37 (at 704); further, at time delta-t later, the FMS is still generating the “drag required” notification 702, and the system 102 additionally calculates and displays an optimized extend speed brakes optimized extend speed brakes magnitude 10 (at 706). In this example, the control module 104 determines that the optimized application of the speed brake (i.e., the position of the speed brakes required to put the aircraft back on the assigned descent path) went from magnitude 37 to magnitude 10, which indicates a decreasing trend. In the example, the control module 104 renders the speed brake widget 410 with a decreasing trend indication 710 on the EICAS page 708. The decreasing trend indication 710 can take a variety of forms, so long as it conveys the information as described herein. In the exemplary embodiment, the decreasing trend indication 710 is a minus sign within a circle.

In FIG. 8, a cockpit display 800 is depicted having a lateral display 814 (often called a navigation display or horizontal situation display, HSD), and a vertical display 812 (often called a vertical situation display, VSD). Ownship aircraft 100 is depicted at the center bottom of the lateral display 814, and at the upper left side of the vertical display 812. A symbol is used to show that the speed reduction mode is underway, and further, to show where speed brake magnitude changes are advised. In FIG. 8, the symbol is overlaid on the ownship aircraft 100 icons to show the recommended speed brake extension (at 804 on the HSD 814, the speed brake extension at magnitude 43 is depicted, and at 808 on the VSD 812, the speed brake extension at magnitude 43 is depicted). In FIG. 8, the symbol is depicted ahead of the aircraft 100, on the path of the aircraft 100, to show a recommended speed brake retraction (at 806 on the HSD 814, the speed brake retraction, and at 810 on the VSD 812, the speed brake retraction). In the exemplary embodiment, the symbol is a hexagon that is sized to be visually distinguishable from other icons and symbols displayed on the cockpit display, while not obscuring the wings or tail of the aircraft 100 icon, however, the symbol can take a variety of forms, so long as it is visually discernable to serve as an alert, and used to convey the information as described herein without obscuring the ownship aircraft 100 icon.

The images 28 of FIGS. 2-8 provide non-limiting examples of this technological enhancement over other flight guidance systems. The images of FIGS. 2-8 are understood to be based on current aircraft status data for the aircraft 100 and to be dynamically modified responsive to continuously obtaining and processing the current aircraft status data. The images 28 may also be continuously updated to reflect real-time changes with respect to terrain, airport features, weather and neighbor traffic/relevant traffic.

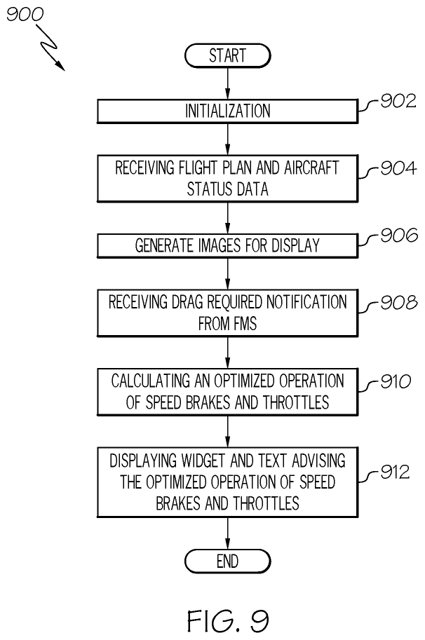

Referring now to FIG. 9 and with continued reference to FIGS. 1-8, a flow chart is provided for a method 900 for optimizing the operation of speed brakes in the aircraft 100, in accordance with various exemplary embodiments. For illustrative purposes, the following description of method 900 may refer to elements mentioned above in connection with FIG. 1. In practice, portions of method 900 may be performed by different components of the described system. It should be appreciated that method 900 may include any number of additional or alternative tasks, the tasks shown in FIG. 9 need not be performed in the illustrated order, and method 900 may be incorporated into a more comprehensive procedure or method having additional functionality not described in detail herein. Moreover, one or more of the tasks shown in FIG. 9 could be omitted from an embodiment of the method 900 if the intended overall functionality remains intact.

The method starts, and at 902 the control module 104 is initialized. As mentioned above, initialization may comprise uploading or updating instructions and applications 160, program 162, stored variables 164, and various lookup tables stored in the database 156. Stored variables may include, for example, a configurable delta airspeed, a configurable delta rate-change, predetermined amounts of time to use as time-thresholds, parameters for setting up a user interface, and the various shapes, various colors and/or visually distinguishing techniques used for icons and alerts. In some embodiments, program 162 includes additional instructions and rules for rendering information differently based on type of display device in display system 112. Initialization at 902 may also include identifying external sources 50 and/or external signals and the communication protocols to use with each of them.

At 904, the prescribed flight plan data and aircraft status data, including location and speed, is received. During operation, it is understood that aircraft status data is continuously received. At 906, one or more images 28 may be generated and displayed on a CDU help window, an EICAS page, a VSD, an HSD, or any combination thereof. Some displayed information may depict navigational information for the aircraft 100, environmental surroundings of the aircraft, and aircraft status data. The displayed images 28 may be continuously updated.

At 908, the control module 104 receives, usually from the FMS 122, a speed-alert notification indicating that the aircraft has departed an assigned descent path. It is to be appreciated that, at 908, the speed-alert may be “drag required” notification or may be a textual speed-alert as provided via other OEMs (such as, “EXTEND SPEED BRAKES” and/or a “RETRACT SPEED BRAKES”). At 910, the control module 104 calculates an optimized operation of the speed brakes and an optimized application of the throttles required to put the aircraft back on the assigned descent path. At 912, displaying, by the control module 104, a speed-brake widget with accompanying text that advises the optimized operation of the speed brakes.

Thus, technologically improved systems and methods for optimizing the operation of speed brakes in an aircraft are provided. As is readily appreciated, the above examples of the system 102 for providing dynamic readouts for a cockpit display are non-limiting, and many others may be addressed by the control module 104.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate the interchangeability of hardware and software, various illustrative components, blocks, modules, circuits, and steps have been described above generally in terms of their functionality. Whether such functionality is implemented as hardware or software depends upon the application and design constraints imposed on the overall system.

Skilled artisans may implement the described functionality in varying ways for each application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

Further, the various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of the method or algorithm described in connection with the embodiments disclosed herein may be embodied directly in hardware, in a software module executed by a controller or processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. When “or” is used herein, it is the logical or mathematical or, also called the “inclusive or.” Accordingly, A or B is true for the three cases: A is true, B is true, and, A and B are true. In some cases, the exclusive “or” is constructed with “and;” for example, “one from the set including A and B” is true for the two cases: A is true, and B is true.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

1. A processor implemented method for optimizing the operation of speed brakes in an aircraft, comprising:
upon generation of, by a flight management system (FMS), a speed-alert that the aircraft has departed an assigned descent path,
calculating a position of the speed brakes that will put the aircraft back on the assigned descent path; and
displaying, on display system, a widget with accompanying text that advises the position of the speed brakes responsive to the speed-alert.

2. The method of claim 1, wherein the speed-alert is an FMS drag required notification.

3. The method of claim 1, wherein the speed-alert is an FMS extend speed brakes notification.

4. The method of claim 1, wherein the position of the speed brakes is from among fully extended, partially extended, and fully retracted, and wherein the widget incorporates a progressive indication of the percent extended.

5. The method of claim 4, wherein partially extended includes a magnitude of application of the speed brakes associated with between 0 and 100 percent extended, and further comprising rendering alphanumeric information indicating, in a control display window (CDU) help window, the magnitude associated with the position of the speed brakes.

6. The method of claim 5, further comprising, ceasing displaying the widget and accompanying text when the aircraft has been brought back to its assigned descent path.

7. The method of claim 6, wherein the display system is a multi-function display system (MFD), and further comprising displaying the widget and accompanying text in an area on the MFD that is used for engine indicators.

8. The method of claim 7, further comprising:
determining that the position of the speed brakes that will put the aircraft back on the assigned descent path follows a decreasing trend; and
rendering the widget with a decreasing trend indication.

9. The method of claim 7, further comprising:
determining that the position of the speed brakes that will put the aircraft back on the assigned descent path follows an increasing trend; and
rendering the widget with an increasing trend indication.

10. A system for optimizing the operation of speed brakes in an aircraft, comprising:
a source of a speed-alert that the aircraft has departed an assigned descent path; and
a control module comprising a processor and programmed to receive the speed-alert;
calculate, responsive to the speed-alert, a position of the speed brakes required to put the aircraft back on the assigned descent path, the position is from among fully extended, partially extended, and fully retracted; and
display, on a display system, a speed-brake widget with accompanying text that advises the position of the speed brakes in response to the speed-alert.

11. The system of claim 10, wherein partially extended includes a magnitude of application of the speed brakes associated with between 0 and 100 percent extended, and the control module is further programmed to render alphanumeric information indicating, in a control display window (CDU) help window, the magnitude associated with the position of the speed brakes.

12. The system of claim 11, wherein the control module is further programmed to render the speed-brake widget with a progressive indication of the percent extended.

13. The system of claim 12, wherein the control module is further programmed to cease displaying the speed-brake widget and accompanying text when the aircraft has been brought back to its assigned descent path.

14. The system of claim 13, wherein the control module is further programmed to:
determine that the position of the speed brakes required to put the aircraft back on the assigned descent path follows a decreasing trend; and
render the speed-brake widget with a decreasing trend indication.

15. The system of claim 13, wherein the control module is further programmed to:
determine that position of the speed brakes required to put the aircraft back on the assigned descent path of the speed brakes follows an increasing trend; and
render the speed-brake widget with an increasing trend indication.

16. The system of claim 13, wherein the control module is further programmed to:
calculate an application of throttles in response to the speed-alert; and
display the application of the throttles next to the widget.

17. An aircraft, comprising:
a flight management system (FMS) that generates a speed-alert that the aircraft has departed an assigned descent path;
a speed brakes system;
a display system; and
a control module operationally coupled to the FMS, the speed brakes system, the display system;
the control module comprising a processor programmed to
calculate, in response to the speed-alert, an optimized operation of the speed brakes required to put the aircraft back on the assigned descent path, wherein the optimized operation of the speed brakes includes a position from among fully extended, partially extended, and fully retracted, partially extended including a magnitude of application of the speed brakes associated with between 0 and 100 percent extended; and
display, on the display system, (i) a speed-brake widget with accompanying text that advises the optimized operation of the speed brakes in response to the speed-alert, and (ii) alphanumeric information indicating the magnitude associated with the position of the speed brakes.

18. The aircraft of claim 17, wherein the processor is further programmed to render the speed-brake widget with a progressive indication of the percent extended.

19. The aircraft of claim 18, wherein the processor is further programmed to cease displaying the speed-brake widget and accompanying text when the aircraft has been brought back to its assigned descent path.

20. The aircraft of claim 19, wherein the processor is further programmed to determine when the optimized application of the speed brakes indicates an decreasing trend;
render the speed-brake widget with a decreasing trend indication when the optimized application of the speed brakes indicates an decreasing trend;
determine when the optimized application of the speed brakes indicates an increasing trend; and
render the speed-brake widget with an increasing trend indication when the optimized application of the speed brakes indicates an increasing trend.
